(19) United States
(12) Patent Application Publication
(10) Pub. No.: US 2017/0138098 A1
(43) Pub. Date: May 18, 2017

(54) HOOD RELEASE SYSTEM FOR A MOTOR VEHICLE THAT AUTOMATICALLY RAISES THE HOOD

(71) Applicant: FORD GLOBAL TECHNOLOGIES, LLC, Dearborn, MI (US)

(72) Inventor: Brian Jashel Covarrubias Pazaran, Los Heroes Coacalco (MX)

(21) Appl. No.: 14/941,121

(22) Filed: Nov. 13, 2015

(51) Int. Cl. E05B 83/24; B60R 13/00; E05B 85/10; B62D 25/12; E05F 1/10

(52) U.S. Cl. CPC E05B 83/24; B62D 25/12; E05F 1/1091; E05B 85/10; B60R 13/005

(57) ABSTRACT

A hood release system is provided for a motor vehicle. That hood release system includes a primary hood latch, a secondary hood latch, a primary hood latch release actuator and a secondary hood latch release actuator. In addition the hood release system includes a hood actuator that automatically raises a hood of the motor vehicle to a fully open position upon release of the primary hood latch and the secondary hood latch. The secondary hood latch release actuator may comprise a grille emblem that is depressed to release the secondary hood latch.

### TECHNICAL FIELD

This document relates generally to the motor vehicle equipment field and, more particularly, to a hood release system that automatically raises the hood to a fully open position upon release of the primary and secondary hood latches.

### BACKGROUND

Many motor vehicle operators find the process of opening the hood to obtain access to the engine compartment to be an inconvenient, unnecessarily complicated and sometimes frustrating task. In most motor vehicles, the operator must first pull the primary hood latch release lever or depress a primary hood latch release button provided in the interior of the vehicle in order to release the primary hood latch. Next, the operator must leave the interior of the vehicle and walk around to the front of the vehicle, raise the hood slightly and search blindly for the secondary hood release lever which is typically hidden from view by the front margin of the hood. That lever must then be pulled to release the secondary hood latch. The operator must then forcibly raise the hood and in many instances, hold the hood open while locating and properly raising and engaging the hood support strut. For certain individuals this can be a physically taxing process and in most instances it involves getting dirt and road grim on the hands and/or the clothing.

This document relates to a new and improved hood release system that greatly simplifies the hood opening process by (a) conveniently locating the secondary hood latch release actuator where it may be easily accessed and utilized and (b) automatically opening the hood and raising and holding the hood in the fully open position upon depressing the secondary hood latch release actuator. Advantageously, the hood release system is compatible with both mechanical and electronic hood latching systems.

### SUMMARY

In accordance with the purposes and benefits described herein, a hood release system is provided for a motor vehicle. That hood release system comprises a primary hood latch, a secondary hood latch, a primary hood latch release actuator, a secondary hood latch release actuator, and a hood actuator. That hood actuator automatically raises the hood of the motor vehicle to a fully open position upon release of the primary hood latch and the secondary hood latch.

In one possible embodiment of the invention, the secondary hood latch release actuator comprises a button on the front of the motor vehicle. In one particularly useful embodiment, the secondary hood latch release actuator comprises the grill emblem carried on the grille of the motor vehicle. That grille emblem is displaceable between a home position, which may be flush with the grille, and a hood release position depressed with respect to the home position.

In one possible embodiment, a mechanical linkage is provided between the primary hood latch release actuator and the primary hood latch. In one possible embodiment, an electronic control line connects the primary hood latch release actuator to an electronic primary hood latch.

In one possible embodiment, a mechanical linkage is provided between the secondary hood latch release actuator and the secondary hood latch. In one possible embodiment, an electronic control line connects the secondary hood latch release actuator to an electronic secondary hood latch.

In one possible embodiment, the hood actuator is a spring. That spring may take the form of a gas strut. In one particularly useful embodiment, the spring is a pair of gas struts: one gas strut attached to a first side margin of the hood and a second gas strut attached to a second side margin of the hood. Together these gas struts raise the hood to a fully open position upon release of the primary and secondary hood latches.

In accordance with an additional aspect, a method of opening a hood of a motor vehicle is provided. Advantageously, that method is accomplished without actually physically touching the hood. That method may be broadly described as comprising the steps of: (a) engaging a primary hood latch actuator to release a primary hood latch for the hood and (b) engaging a grille emblem of the motor vehicle to release a secondary hood latch for the hood and thereby allow a hood actuator to automatically raise the hood to a fully open position. More specifically, the method may include depressing the grille emblem in order to release the secondary hood latch and open the hood.

In the following description, there are shown and described several preferred embodiments of the hood release system. As it should be realized, the hood release system is capable of other, different embodiments and its several details are capable of modification in various, obvious aspects all without departing from the hood release system as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the hood release system and together with the description serve to explain certain principles thereof. In the drawing figures:

FIG. 1 is a schematic block diagram of the hood release system.

FIG. 2 is a perspective view of the front of a motor vehicle equipped with the hood release system of FIG. 1 and clearly illustrating a grille emblem in the center of the motor vehicle grille that functions as a secondary hood latch release actuator.

FIG. 3 is a perspective view of the motor vehicle illustrated in FIG. 2 with the hood shown in the open position and held in place by the hood actuator in the form of two gas struts.

Reference will now be made in detail to the present preferred embodiments of the hood release system, examples of which are illustrated in the accompanying drawing figures.

### DETAILED DESCRIPTION

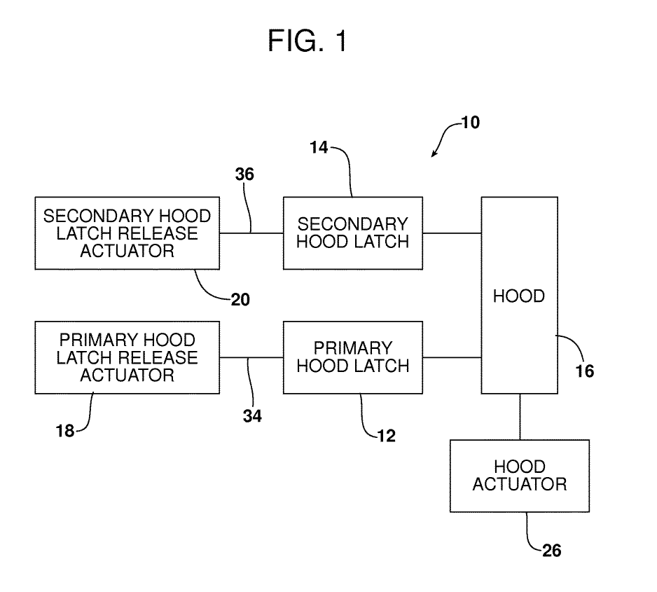

Reference is now made to FIGS. 1-3 illustrating the hood release system 10 for a motor vehicle M. As illustrated, the hood release system 10 includes a primary hood latch 12 and a secondary hood latch 14 for securing the hood 16 in a closed position.

The hood release system 10 also includes a primary hood latch release actuator 18 that may be manipulated by the vehicle operator to release the primary hood latch 12. That primary hood latch release actuator 18 may comprise, for example, a release lever that may be pulled or a push button that may be depressed to release the primary hood latch 12. Typically the primary hood latch release actuator 18 is located in the interior of the motor vehicle where it can be easily accessed by the driver when seated in the driver's seat behind the steering wheel of the motor vehicle. It should be appreciated that the primary hood latch release actuator 18 may be connected to and release the primary hood latch 12 via a mechanical linkage or via an electronic control line where the primary hood latch is electronic in nature. The mechanical linkage/electronic control line are both represented in FIG. 1 by the reference number 34.

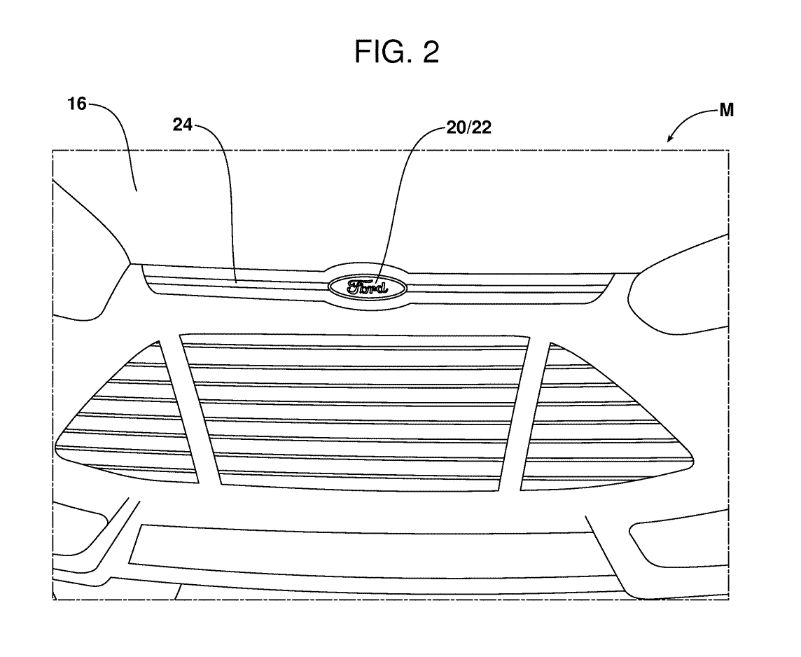

The hood release system 10 also includes a secondary hood latch release actuator 20. The secondary hood latch release actuator 20 is connected to the secondary hood latch 14 and is manipulated by the vehicle operator in order to release the secondary hood latch. As best illustrated in FIG. 2, in a particularly useful embodiment, the secondary hood latch release actuator 20 includes a face forming a grille emblem 22 that may be positioned, for example, in the middle of the grille 24 of the motor vehicle M.

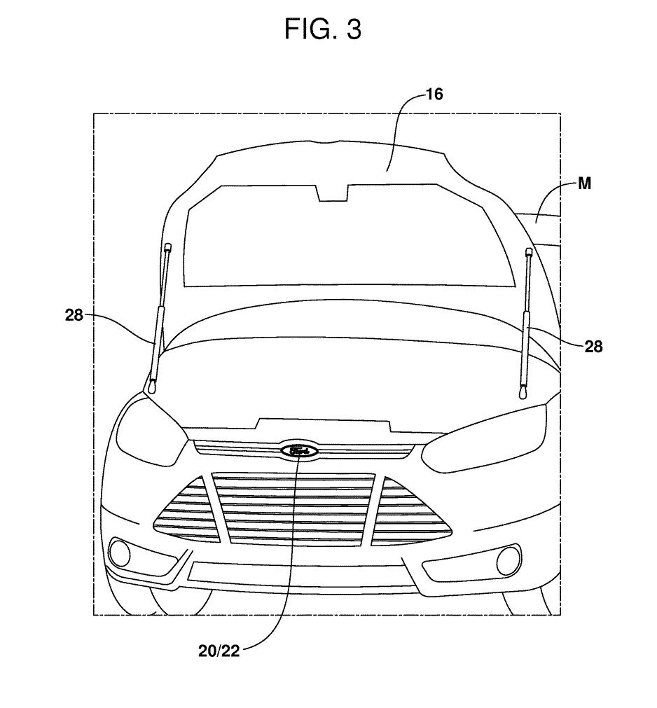

As further illustrated in FIG. 3, the hood release system 10 also includes a hood actuator 26. That hood actuator 26 may take the form of a spring such as the two gas struts 28 illustrated in FIG. 3. As should be appreciated a first of the gas struts 28 is attached to a first side margin 30 of the hood 16 while a second of the gas struts 28 is attached to a second side margin 32 of the hood 16. Together, the gas struts 28 provide sufficient force to raise the hood and to hold the hood 16 in the fully open position illustrated in FIG. 3 upon release of the primary hood latch 12 and the secondary hood latch 14.

When a vehicle operator wishes to raise the hood 16, he engages and manipulates the primary hood latch actuator 18 in order to release the primary hood latch 12. At that point the secondary hood latch 14 still secures the hood 16 against opening to a fully open position.

Next, the vehicle operator approaches and engages the secondary hood latch release actuator 20. More specifically, the operator walks up to the grille 24 and depresses the grille emblem 22 with respect to the grille thereby releasing the secondary hood latch 14. Here it should be appreciated that the secondary hood latch release actuator 20 may be operatively connected to a mechanical secondary hood latch 14 by means of a mechanical linkage such as a cable. In contrast, the secondary hood latch release actuator 20 may be operatively connected to an electronic secondary hood latch 14 by means of an electronic control line. The mechanical linkage/electronic control line between the secondary hood latch release actuator 20 and the secondary hood latch 14 is represented in FIG. 1 by the reference number 36.

At that point the hood actuator 26 (that is, the pair of gas struts 28 in the illustrated embodiment) raise the hood 16 to the fully open position illustrated in FIG. 3 and hold that hood in position. Advantageously, it should be appreciated that this is done without any physical exertion on the part of the vehicle operator beyond manipulating the primary hood latch release actuator 18 and then depressing the secondary hood latch release actuator/grille emblem 22. Thus it should be appreciated that the hood 16 is opened in a most effective and convenient manner with only the smallest of burdens placed upon the vehicle operator. Since the hood 16 is raised by the gas struts 28 in a hands-free manner, it should also be appreciated that the operator does not need to get dirt and road grime on his hands or his clothing.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A hood release system for a motor vehicle, comprising:
a primary hood latch;
a secondary hood latch;
a primary hood latch release actuator;
a secondary hood latch release actuator; and
a hood actuator that automatically raises a hood of the motor vehicle to a fully open position upon release of said primary hood latch and said secondary hood latch.

2. The hood release system of claim 1 wherein said secondary hood latch release actuator comprises a button on a front of the motor vehicle.

3. The hood release system of claim 1 wherein said secondary hood latch release actuator comprises a grille emblem carried on a grille of said motor vehicle.

4. The hood release system of claim of claim 3 wherein said grille emblem is displaceable between a home position and a hood release position depressed with respect to said home position.

5. The hood release system of claim 4, wherein said hood actuator is a spring.

6. The hood release system of claim 5, wherein said spring is a gas strut.

7. The hood release system of claim 6, wherein said spring is a pair of gas struts, a first strut of said pair of gas struts being attached to a first side margin of said hood and a second strut of said pair of gas struts being attached to a second side margin of said hood.

8. The hood release system of claim 1, wherein said hood actuator is a spring.

9. The hood release system of claim 8, wherein said spring is a gas strut.

10. The hood release system of claim 8, wherein said spring is a pair of gas struts, a first strut of said pair of gas struts being attached to a first side margin of said hood and a second strut of said pair of gas struts being attached to a second side margin of said hood.

11. The hood release system of claim 1 including a mechanical linkage between said primary hood latch release actuator and said primary hood latch.

12. The hood release system of claim 1, including an electronic control line between said primary hood latch release actuator and said primary hood latch.

13. The hood release system of claim 1, including a mechanical linkage between said secondary hood latch release actuator and said secondary hood latch.

14. The hood release system of claim 1, including an electronic control line between said secondary hood latch release actuator and said secondary hood latch.

15. A hood release system for a motor vehicle, comprising:
a primary hood latch for securing a hood of said motor vehicle in a fully closed position;
a secondary hood latch for securing said hood against opening when said primary hood latch has been released;
a primary hood latch release actuator for releasing said primary hood latch;
a secondary hood latch release actuator for releasing said secondary hood latch after said primary hood latch has been released, said secondary hood latch release actuator consisting of a grille emblem carried on a grille of said motor vehicle; and
a hood actuator for automatically opening said hood upon release of said primary hood latch and said secondary hood latch whereby said hood is raised to a fully open position in response to depressing said grille emblem.

16. A method of opening a hood of a motor vehicle without actually physically touching said hood, said method comprising:
engaging a primary hood latch actuator to release a primary hood latch for said hood; and
engaging a grille emblem of said motor vehicle to release a secondary hood latch for said hood and thereby allowing a hood actuator to automatically raise said hood into a fully open position.

17. The method of claim 16 including depressing said grille emblem to release said secondary hood latch and open said hood.
